(19) United States
(12) Patent Application Publication
(10) Pub. No.: US 2017/0161874 A1
(43) Pub. Date: Jun. 8, 2017

(54) METHOD AND ELECTRONIC APPARATUS FOR PROCESSING IMAGE DATA

(71) Applicants: Le Holdings (Beijing) Co., Ltd., Beijing (CN); LeCloud Computing Co., Ltd., Beijing (CN)

(72) Inventors: Fan Yang, Beijing (CN); Yang Liu, Beijing (CN); Yangang Cai, Beijing (CN); Maosheng Bai, Beijing (CN); Wei Wei, Beijing (CN)

(21) Appl. No.: 15/247,213

(22) Filed: Aug. 25, 2016

Related U.S. Application Data
(63) Continuation of application No. PCT/CN2016/088652, filed on Jul. 5, 2016.

(30) Foreign Application Priority Data
Dec. 7, 2015 (CN) 201510892175.2

(51) Int. Cl. G06T 3/40; G06T 5/20; G06T 7/40; G06T 7/00; G06T 5/00

(52) U.S. Cl. CPC G06T 3/4023; G06T 7/0026; G06T 5/002; G06T 7/408; G06T 5/20; G06T 2207/20012

(57) ABSTRACT

Embodiments of the present disclosure provide a method and electronic apparatus for processing image data, including: taking an inserted pixel as a center point, determining neighbor pixel; obtaining gradient magnitudes and directions of each neighbor pixel; calculating correlations between each neighbor pixel and the center point; calculating the gradient magnitudes of each neighbor pixel and the correlations between the neighbor pixel and the center point to obtain gray scale of the center point which is gray scale of the inserted pixel; taking the other inserted pixels each as a center point to obtain gray scale thereof, and determining color of each inserted pixel according to all the gray scales of the inserted pixels, and obtaining an image with increased image resolution by fully considering the patterns and features of the image, so it can maintain original patterns and features of the original image to become more vivid and natural.

### CROSS REFERENCE TO RELATED APPLICATIONS

This application is a continuation of International Application No. PCT/CN2016/088652, filed on 5 Jul. 16, which is based upon and claims priority to Chinese Patent Application No. 201510892175.2, filed on 7 Dec. 15, the entire contents of which are incorporated herein by reference.

### TECHNICAL FIELD

The present disclosure relates to image processing, more particularly to a method and electronic apparatus of processing image data.

### BACKGROUND

Upsampling interpolation is a general method of increasing or recovering the resolution of an image. It increases the size of pixels in the image, and based on the colors, uses an algorithm to calculate the color of lost pixel. The common interpolation includes, for example, nearest pixel neighbor interpolation, bilinear interpolation, bicubic interpolation, Lagrange interpolating polynomial, Newton interpolating polynomial. However, these interpolations are basically based on mathematical formulas, and they do not take patterns and features of the image into account. Thus, after the resolution of the image is increased or recovered by these interpolations, the patterns and the features of the image are looks stiff and unnatural.

### SUMMARY

One embodiment of the present disclosure provides a method and electronic apparatus for processing image data, for solving the problem in the traditional technique that the patterns and features of the image are looks unnatural after the resolution of the image is increased or recovered.

One embodiment of the present disclosure provides a method of processing image data, the method includes:

taking an inserted pixel as a center point, and determining neighbor pixels of the center point;

calculating and obtaining gradient magnitudes and directions of each neighbor pixel;

calculating correlations between each neighbor pixel and the center point according to the directions of each neighbor pixel;

considering the gradient magnitudes of each neighbor pixel and the correlations between the gradient magnitudes and the center point to obtain gray scale of the center point (i.e. the gray scale of the inserted pixel);

taking the other inserted pixels each as a center point to obtain gray scale thereof, and determining color of each inserted pixel according to all the gray scales of the inserted pixels; and

obtaining an image with increased resolution according to each inserted pixel and the color thereof and original pixels and the color thereof;

wherein, the correlation is determined by whether the direction of the neighbor pixel passes through the center point and the position in which the direction of the neighbor pixel passes through the center point.

One embodiment of the present disclosure provides a non-volatile computer storage medium capable of storing computer-executable instruction. The said computer-executable instruction is used for performing any one of the steps in above.

One embodiment of the present disclosure provides an electronic apparatus, includes: at least one processor and memory; wherein the memory stores at least one process which can be performed by the processor. The computer-executable instruction is performed by the at least one processor so that the at least one processor can perform any one of the step as discussed in above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart illustrating a method of processing image data according to one embodiment of the present disclosure;

FIG. 2 is a enlarged schematic view of an original image having a size of 5×4 being increased to 7×7;

FIG. 3a is a schematic diagram illustrating direction of inserted pixel p0 in FIG. 2;

FIG. 3b is another schematic diagram illustrating direction of inserted pixel p0 in FIG. 2;

FIG. 4 is a schematic view of a device for processing image data according to one embodiment of the present disclosure; and

FIG. 5 is a schematic view of an electronic apparatus for processing image data according to one embodiment of the present disclosure.

### DETAILED DESCRIPTION

For more clearly illustrating the purpose, technology and advantages of the present disclosure, the following paragraphs and related drawings are provided for thoroughly describing the features of the embodiments of the present disclosure. It is evident that these embodiments are merely illustrative and not exhaustive embodiments of the present disclosure. Based on the embodiments in the present disclosure, the other embodiments conceived by the people skilled in the art without putting inventive effort fall within the scope of the present disclosure.

One embodiment of the present disclosure provides a method and electronic apparatus of processing image data for processing image resolution. Upsampling Interpolation is a general method used to increase or recover the image resolution of an image. By computing color references of neighbor pixels around inserted pixel through formula to obtain gray scale of the inserted pixel. The related computing method includes nearest pixel neighbor interpolation, Bilinear Interpolation, or Bicubic Interpolation. etc, but these methods only take the color references of the neighbor pixels, e.g. gray scale, into account, but do not take patterns and features of the whole image into account. Therefore, the color of the inserted pixels generated by the aforementioned methods can not be fitted into the original image very well, which makes the patterns and the features of the image with increased image resolution looks weird and unnatural.

One embodiment of the present disclosure provides a method and electronic apparatus of processing image data in order to overcome the aforementioned problems. The method includes: obtaining gradient magnitudes and directions of neighbor pixels around the inserted pixel to predict patterns and features of the whole image around the inserted pixel; and then calculating gray scale of the inserted pixel by fully considering the patterns and features of the image. Therefore, color of the inserted pixel can be well fitted into the color of the original image, so the image with increased or recovered image resolution has the patterns and features of the original one, and the image looks more natural when it is at a close look.

In addition, the method and electronic apparatus of the present disclosure can be adapted to video processing or other image processing related fields, but the present disclosure is not limited thereto.

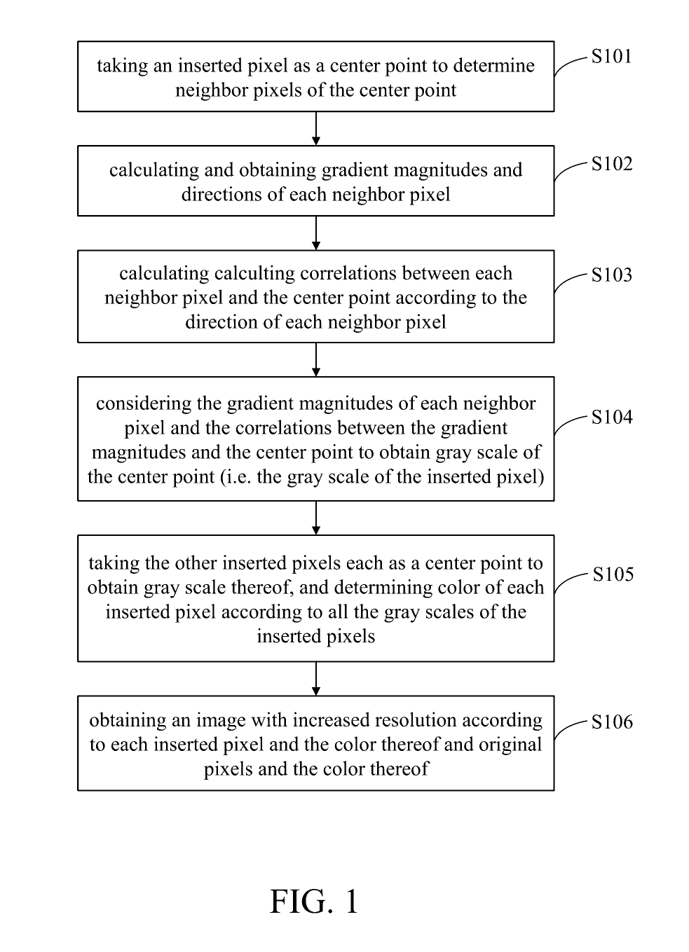

Please refer to FIG. 1, one embodiment of the present disclosure provides a method of processing image data including:

S101: taking an inserted pixel as a center point to determine neighbor pixels of the center point;

S102: calculating and obtaining gradient magnitudes and directions of each neighbor pixel;

S103: calculating correlations between each neighbor pixel and the center point according to the directions of each neighbor pixel;

S104: considering the gradient magnitudes of each neighbor pixel and the correlations between the gradient magnitudes and the center point to obtain gray scale of the center point (i.e. the gray scale of the inserted pixel);

S105: taking the other inserted pixels each as a center point to obtain gray scale thereof, and determining color of each inserted pixel according to all the gray scales of the inserted pixels; and

S106: obtaining an image with increased resolution according to each inserted pixel and the color thereof and original pixels and the color thereof;

wherein, the correlation is determined by whether the direction of the neighbor pixel passes through the center point and the position where the direction of the neighbor pixel passes through the center point.

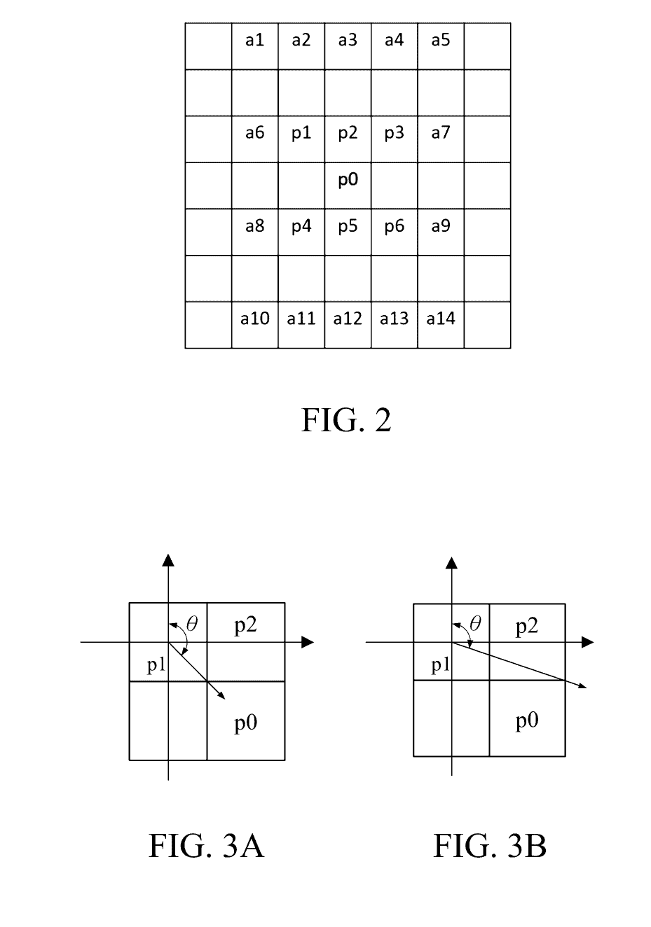

In the step S101, an inserted pixel needed to be determined its gray scale is taken as a center point. Original pixels around the center point are taken as neighbor pixels, or the original pixels around the center point and the inserted pixels which have been calculated their gray scales are taken as neighbor pixels. For example, for an inserted pixel p0 in FIG. 2, its neighbor pixels are p1, p2, p3, p4, p5 and p6, but the present disclosure is not limited to the number of the neighbor pixels.

In step S102, according to the neighbor pixels determined in the step 101, gradient magnitudes and directions of each neighbor pixel are calculated. For example, as shown in FIG. 2, the gradient magnitudes and the directions of the neighbor pixels p1, p2, p3, p4, p5, and p6 are calculated.

In step S103, whether the neighbor pixel passes through the center point and the position in which the neighbor pixel passes through the center point are determined according to the directions of the neighbor pixel. For example, correlation between the neighbor pixel and the center point is determined by taking whether the direction of the neighbor pixel passes through the center point or the periphery of the center point into account.

In step S104, gray scale of the center point is determined according to the gradient magnitudes of the neighbor pixels provided by the step S102 and the correlations between neighbor pixels and the center point provided by the step S103, that is, the gray scale of the currently inserted pixel is determined.

In step S105, gray scales of the other inserted pixels are determined by following the steps S101-104, and color of each inserted pixel is determined by the gray scale of each inserted pixel. Finally, in step S106, the image with increased or recovered image resolution is obtained.

The following is an embodiment for explaining the step S102.

In step S102, the gradient magnitudes of the neighbor pixels can be obtained by calculating gradients of the neighbor pixel in x-direction and y-direction, and there are many ways to calculate gradients of the neighbor pixel in x-direction and y-direction, e.g. Sobel operator, Scharr operator, Laplace operator, Prewitt operator. etc. The present embodiment takes the Sobel operator as an example for explaining gradients calculating:

For satisfying the order of the four quadrants in common mathematical functions, it is determined that positive number is on the right side of the x-direction operator, negative number is on the left side of the x-direction operator, that positive number is on the top side of the y-direction operator, negative number is on the bottom side of the y-direction operator. Neighbor pixel p1 in FIG. 2 is taken as an example:

gradient dₓ^{p}^{₁} of the neighbor pixel in x-direction is calculated according to dₓ^{p}^{₁}=(a₃−a₁)+2□(p₂−a₆)+(p₅−a₈), wherein, a₁, a₃, a₆, a₈, p₂, p₅ are gray scales of the original pixels in the neighbor pixel;

gradient d_{y}^{p}^{₁} of the neighbor pixel in y-direction is calculated according to d_{y}^{p}^{₁}=(a₁−a₈)+2□(a₂−p₄)+(a₃−p₅), wherein, a₁, a₂, a₃, a₈, p₄, p₅ are gray scales of the original pixels in the neighbor pixel;

then, gradient magnitude dₚ_{₁} of the neighbor pixel p1 is determined according to dₚ_{₁}=\sqrt{(dₓ^{p}^{₁})²+(d_{y}^{p}^{₁})²};

then, a direction θₚ_{₁} of the neighbor pixel is determined according to

$${θ}_{{p}_{1}} {tan}^{- 1} \frac{{d}_{y}^{{p}_{1}}}{{d}_{x}^{{p}_{1}}} .$$

The following is an embodiment for explaining step S103.

For each neighbor pixel, whether its direction or an extending direction of its opposite direction passes through the center point can be used to determine whether the pattern of the image on the neighbor pixel should be taken as a reference of determining gray scale of the center point. For example, in FIG. 3a, the direction of the neighbor pixel p1 passes through center point p0, so the pattern of the image on the neighbor pixel p1 is taken as a reference when determining gray scale of the center point p0; but in FIG. 3b, the direction of the neighbor pixel p1 does not pass through the center point p0, so the pattern of the image on the neighbor pixel p1 is not taken into account when determining gray scale of the center point p0.

In this embodiment, each neighbor pixel is defined as a 1×1 square, if a direction θₚ_{₁} of the neighbor pixel is in [2π−tan⁻¹3, 2π−tan⁻¹⅓], or an extending direction of the opposite direction θₚ_{₁} of the neighbor pixel is in [π−tan⁻¹3, π−tan⁻¹⅓], the neighbor pixel and the center point are defined that they have correlation, and the neighbor pixel is marked with a correlation symbol according to

$${s}_{{p}_{1}} = \{ \begin{matrix}1 when \text{:} 2 π - {tan}^{- 1} 3 \leq {θ}_{{p}_{1}} \leq 2 π - {tan}^{- 1} \frac{1}{3} \\ - 1 when \text{:} π - {tan}^{- 1} 3 \leq {θ}_{{p}_{1}} \leq π - {tan}^{- 1} \frac{1}{3}\end{matrix} .$$

Please refer to FIGS. 3a and 3b, when each neighbor pixel or each center point is taken as a 1×1 square, the range of a direction of a neighbor pixel p1 passing through the center point is determined by:

$$\{ \begin{matrix}2 π - {tan}^{- 1} 3 \leq {θ}_{{p}_{1}} \leq 2 π - {tan}^{- 1} \frac{1}{3} \\ π - {tan}^{- 1} 3 \leq {θ}_{{p}_{1}} \leq π - {tan}^{- 1} \frac{1}{3}\end{matrix} .$$

When a direction or an extending direction of the neighbor pixel p1 is within the aforementioned range, the neighbor pixel p1 and the center point p0 are determined to be related, and the neighbor pixel p1 is marked with respective correlation symbol. The correlation symbol is used to represent that the direction or the extending direction of the neighbor pixel passes through the center point.

As discussed in above, the correlation between the neighbor pixel and the center point is further related to the position in which the neighbor pixel passes through the center point. For example, in FIG. 3a, the direction of the neighbor pixel p1 passes through the center of the center point p0, that is, θₚ_{₁}=135 in such case, the correlation between the neighbor pixel p1 and the center point p0 is strongest. In addition, if θₚ_{₁}=135, the correlation between the neighbor pixel p1 and the center point p0 is strongest as well; but when θₚ_{₁} passes through the periphery of the center point, the correlation between the neighbor pixel and the center point is weakest. Therefore, this embodiment follows:

$${c}_{{p}_{1}} = \{ \begin{matrix}\frac{1}{{tan}^{- 1} \frac{1}{3} - \frac{π}{4}} \times {θ}_{{p}_{1}} + \frac{{tan}^{- 1} \frac{1}{3} - 2 \times π}{{tan}^{- 1} \frac{1}{3} - \frac{π}{4}} when \text{:} \begin{matrix}\frac{7}{4} \times π \leq {θ}_{{p}_{1}} \leq \\ 2 π - {tan}^{- 1} \frac{1}{3}\end{matrix} \\ \frac{1}{{tan}^{- 1} 3 - \frac{π}{4}} \times {θ}_{{p}_{1}} + \frac{{tan}^{- 1} 3 - 2 \times π}{{tan}^{- 1} 3 - \frac{π}{4}} when \text{:} \begin{matrix}2 π - {tan}^{- 1} 3 \leq \\ {θ}_{{p}_{1}} \leq \frac{7}{4} \times π\end{matrix} \\ \frac{1}{{tan}^{- 1} \frac{1}{3} - \frac{π}{4}} \times {θ}_{{p}_{1}} + \frac{{tan}^{- 1} \frac{1}{3} - π}{{tan}^{- 1} \frac{1}{3} - \frac{π}{4}} when \text{:} \begin{matrix}\frac{3}{4} \times π \leq {θ}_{{p}_{1}} \leq \\ π - {tan}^{- 1} \frac{1}{3}\end{matrix} \\ \frac{1}{{tan}^{- 1} 3 - \frac{π}{4}} \times {θ}_{{p}_{1}} + \frac{{tan}^{- 1} 3 - π}{{tan}^{- 1} 3 - \frac{3}{4} \times π} when \text{:} \begin{matrix}π - {tan}^{- 1} 3 \leq \\ {θ}_{{p}_{1}} \leq \frac{3}{4} \times π\end{matrix} \\ 0 other\end{matrix} .$$

The correlation levels cₚ_{₁} of the neighbor pixels and the center point are calculated according to the range of the directions of the neighbor pixels, and the correlations between the neighbor pixels and the center point are confirmed according to the correlation symbols of the neighbor pixels and the correlation levels.

In this embodiment, correlation between each neighbor pixel and the center point is confirmed by analyzing the correlation symbol and the correlation level between the neighbor pixels and the center point, for providing references to the later process of calculating gray scale of the center point.

The present embodiment provides an exemplary calculation in related to correlation symbol and correlation lever between the neighbor pixels and the center point, but the present disclosure is not limited thereto, other calculations in related to determining correlation symbol and correlation level fall within the scope of the present disclosure.

The following is an embodiment for explaining the step S104.

In this embodiment, the step S104 further includes: calculating gray scale of the center point according to

$${p}_{0} = \frac{1}{n} \times {\sum }_{i = 1}^{n} {d}_{{p}_{i}} \times {c}_{{p}_{i}} {s}_{{p}_{i}} ,$$

wherein p₀ represents the gray scale of the center point, n represents number of the neighbor pixel, dₚ_{ᵢ} represents the gradient magnitudes of the i^{th} neighbor pixel, cₚ_{ᵢ} represents the correlation lever of the i^{th} neighbor pixel, and sₚ_{ᵢ} represents the correlation symbol of the i^{th} neighbor pixel.

In this embodiment, according to the gradient magnitudes of each neighbor pixel and the correlations between the neighbor pixels and the center point provided by the steps S102-103, gray scale of the center point is obtained, in this embodiment, correlations between the neighbor pixels and the center point is confirmed by both the correlations and the correlation level, but this is exemplary, the present disclosure is not limited thereto, other ways to confirm the correlation between the neighbor pixels and the center point fall within the scope of the present disclosure.

When neighbor pixel of the neighbor pixels provided by the step S101 is confirmed to have correlations with the center point, gray scale of the center point can be determined by gradient magnitudes and directions of each neighbor pixel having correlations with the center point. In addition, there is an extreme situation, that is, when the neighbor pixel provided by the step S101 and the center point do not have correlation therebetween, the way of confirming the gray scale of the center point provided in this embodiment is not applicable.

The following are more embodiments for explaining the way to confirm the gray scale of the center point when the neighbor pixels and the center point provided by the step S101 do not have correlation therebetween.

In one embodiment, if all the neighbor pixels provided by step S101 and the center points do not have correlation, average gray scale of each neighbor pixel is calculated, and the average gray scale is taken as the gray scale of the center point. For example, if all the gray scales of the neighbor pixels are the same, the gray scale of the inserted pixel can be obtained by the way mentioned in the present embodiment.

In another embodiment, if all the neighbor pixels provided by step S101 and the center points do not have correlation, the number of the neighbor pixels can be increased, so gray scale of the center point can be calculated according to the correlations between the gradient magnitude of the added neighbor pixels and the center point. For example, the number of the neighbor pixels around the center point can be increased from 6 to 14, the number can still be increased if the neighbor pixels and the center point have no correlation therebetween.

When the neighbor pixels and the center point have correlations therebetween, gray scale of the center point is determined according to the gradient magnitudes and directions of the neighbor pixels having correlations with the center point.

An example of enlarging a 5×4 image to a 7×7 image is described in below for detail explaining embodiments of the present disclosure.

As shown in FIG. 2, a1-a14 and p1-p6 represent original pixels of original image, and the rest pixels are inserted pixels. An inserted pixel p0 is taken as an example, neighbor pixels p1-p6 are determined, and correlations between the gradient magnitudes of each p1-p6 and p0 is calculated. The neighbor pixel p1 is taken as an example, firstly, gradients of p1 in x-direction and y-direction are calculated: dₓ^{p}^{₁}=(a₃−a₁)+2□(p₂−a₆)+(p₅−a₈); d_{y}^{p}^{₁}=(a₁−a₈)+2□(a₂−p₄)+(a₃−p₅), and then the gradient magnitude dₚ_{₁}=\sqrt{(dₓ^{p}^{₁})²+(d_{y}^{p}^{₁})²} of p1 and the direction

$${θ}_{{p}_{1}} = {tan}^{- 1} \frac{{d}_{y}^{{p}_{1}}}{{d}_{x}^{{p}_{1}}} = 125$$

of p1 are calculated to determine the relationship between p1 and p0 so as to mark correlation symbol sₚ_{₁} on p1, and according to:

$${c}_{{p}_{1}} = \frac{1}{{tan}^{- 1} \frac{1}{3} - \frac{π}{4}} \times {θ}_{{p}_{1}} + \frac{{tan}^{- 1} \frac{1}{3} - 2 \times π}{{tan}^{- 1} \frac{1}{3} - \frac{π}{4}}$$

Correlation level of p1 is calculated, and correlation between p1 and p0 are determined according to correlation symbol and correlation level of p1. Then, correlations between gradient magnitudes of p2-p6 and p0 can be obtained by following the same way, and thereby obtaining gray scale of p0.

Then, gray scale of each horizontal inserted pixel and gray scale of each vertical inserted pixel can be determined by following the aforementioned methods, and then color of each inserted pixel can be determined according to the setting of the gray scale of each inserted pixel, so the enlarged image (7×7 image) is composed by the original pixel and the inserted pixels which are fitted into color of the original pixel. Therefore, the patterns and features of the enlarged image are looks natural.

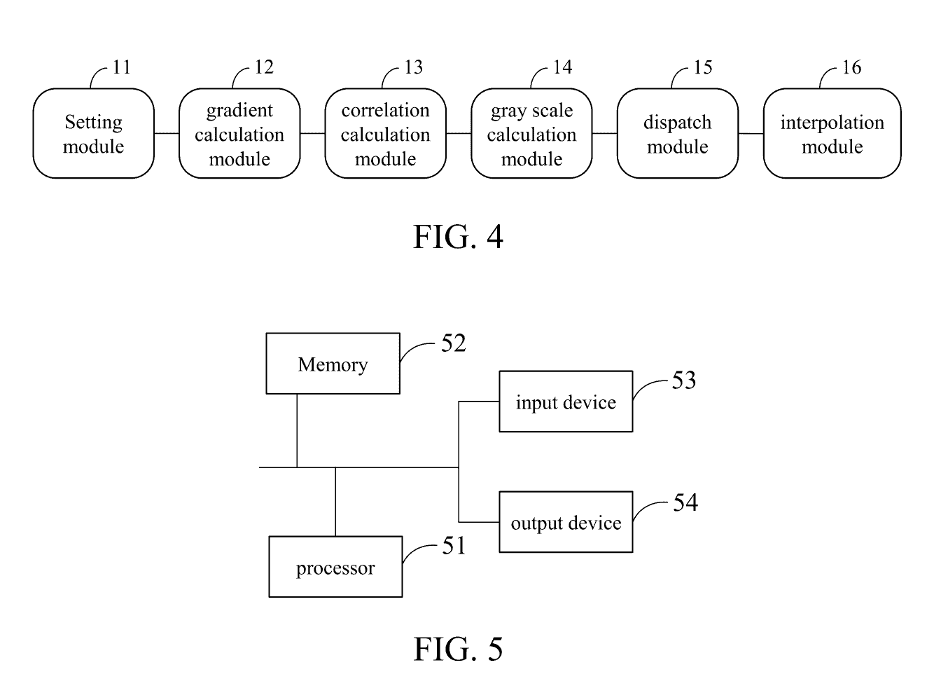

Please refer to FIG. 4, one embodiment of the present disclosure provides a device for processing image data, the device includes:

a setting module 11 used to take an inserted pixel as a center point and determine neighbor pixels of the center point;

a gradient-direction calculation module 12 used to obtain directions and gradient magnitudes of each neighbor pixel;

a correlation calculation module 13 used to calculate correlations between each neighbor pixel and the center point according to the directions of each neighbor pixel;

a gray scale calculation module 14 used to consider the gradient magnitudes of each neighbor pixel and the correlations between the gradient magnitudes and the center point to obtain gray scale of the center point (i.e. the gray scale of the inserted pixel);

a dispatch module 15 used to take the other inserted pixels each as a center point to obtain gray scale thereof, and determine color of each inserted pixel according to all the gray scales of the inserted pixels;

an interpolation module 16 used to obtain an image with increased image resolution according to each inserted pixel and the color thereof and original pixels and the color thereof;

wherein, the correlation is determined by whether the direction of the neighbor pixel passes through the center point and the position in which the direction of the neighbor pixel passes through the center point;

wherein, in the setting module 11, the inserted pixel needed to be determined it's gray scale is taken as a center point, according to the position of the center point, pixels around the original pixel are taken as neighbor pixels, or the neighborhood original pixel and the inserted pixels with determined gray scales can be taken as neighbor pixels. For an example in FIG. 2, for the inserted pixel p0, the neighbor pixels are p1, p2, p3, p4, p5, p6, but the present disclosure is not limited to the number of the neighbor pixels.

In the gradient-direction calculation module 12, directions and gradient magnitudes of each neighbor pixel is determined according to the neighbor pixels provided by the step S101, for example, gradient magnitudes and directions of neighbor pixels p1, p2, p3, p4, p5, p6 in FIG. 2 are calculated.

In the correlation calculation module 13, whether the neighbor pixel passes through the center point and the position of the neighbor pixel where the neighbor pixel passes through the center point are determined according to the directions of the neighbor pixel. For example, the correlation between the neighbor pixel and the center point is determined by whether the direction of the neighbor pixel passes through the center point or the periphery of the center point.

In the gray scale calculation module 14, gray scale of the center point is determined according to the gradient magnitudes of each neighbor pixel provided by the gradient-direction calculation module 12 and the correlations between each neighbor pixel and the center point provided by the correlation calculation module 13. That is, the gray scale of the currently inserted pixel is determined.

In the dispatch module 15, gray scales of the other inserted pixels are determined by the gradient-direction calculation module 12, the correlation calculation module 13, and the gray scale calculation module 14, and color of each inserted pixel is determined by the gray scale of each inserted pixel. Finally, the interpolation module 16 obtains a new image with increased or recovered image resolution is obtained.

There is an embodiment for explaining the gradient-direction calculation module in detail.

In the gradient-direction calculation module 12, the gradient magnitudes of the neighbor pixel can be obtained according to gradients of the neighbor pixel in x-direction and y-direction. There are many methods of calculating gradients of the neighbor pixel in x-direction and y-direction, e.g. Sobel operator, Scharr operator, Laplace operator, Prewitt operator. etc. In this embodiment, the Sobel operator is taken as an example:

The gradient-direction calculation module 12 is further used to:

calculate gradient dₓ^{p}^{₁} of the neighbor pixel in x-direction according to dₓ^{p}^{₁}=(a₃−a₁)+2□(p₂−a₆)+(p₅−a₈), wherein, a₁, a₃, a₆, a₈, p₂, p₅ are gray scales of the original pixels in the neighbor pixel;

calculate gradient d_{y}^{p}^{₁} of the neighbor pixel in y-direction according to d_{y}^{p}^{₁}=(a₁−a₈)+2□(a₂−p₄)+(a₃−p₅), wherein, a₁, a₂, a₃, a₈, p₄, p₅ are gray scales of the original pixels in the neighbor pixel;

calculate gradient magnitude dₚ_{₁} of the neighbor pixel according to dₚ_{₁}=\sqrt{(dₓ^{p}^{₁})²+(d_{y}^{p}^{₁})²}; and

calculate direction θₚ_{₁} of the neighbor pixel according to

$${θ}_{{p}_{1}} = {tan}^{- 1} \frac{{d}_{y}^{{p}_{1}}}{{d}_{x}^{{p}_{1}}} .$$

There is an embodiment for explaining the correlation calculation module 13.

For each neighbor pixel, whether its direction or an extending direction of its opposite direction passes through the center point can be used to determine whether the pattern of the image on the neighbor pixel should be taken as a reference of determining gray scale of the center point, for example, in FIG. 3a, the direction of the neighbor pixel p1 passes through the center point p0, so the pattern of the image on the neighbor pixel p1 is taken as a reference when determining gray scale of the center point p0; but in FIG. 3b, the direction of the neighbor pixel p1 does not pass through the center point p0, so the pattern of the image on the neighbor pixel p1 is not taken into account when determining gray scale of the center point p0.

In this embodiment, the correlation calculation module 13 is further used to: define each neighbor pixel as a 1×1 square, wherein if the direction θₚ_{₁} of the neighbor pixel is in [2π−tan⁻¹3, 2π−tan⁻¹⅓], or an extending direction θₚ_{₁} of the opposite direction of the neighbor pixel is in [π−tan⁻¹3, π−tan⁻¹⅓], define the neighbor pixel and the center point has correlation, and the neighbor pixel is marked with a correlation symbol according to

$${s}_{{p}_{1}} = \{ \begin{matrix}1 when \text{:} 2 π - {tan}^{- 1} 3 \leq {θ}_{{p}_{1}} \leq 2 π - {tan}^{- 1} \frac{1}{3} \\ - 1 when \text{:} π - {tan}^{- 1} 3 \leq {θ}_{{p}_{1}} \leq π - {tan}^{- 1} \frac{1}{3}\end{matrix} .$$

Please refer to FIGS. 3a and 3b, when each neighbor pixel or the center point is taken as a 1×1 square, the range of the direction of the neighbor pixel p1 passing through the center point is:

$$\{ \begin{matrix}2 π - {tan}^{- 1} 3 \leq {θ}_{{p}_{1}} \leq 2 π - {tan}^{- 1} \frac{1}{3} \\ π - {tan}^{- 1} 3 \leq {θ}_{{p}_{1}} \leq π - {tan}^{- 1} \frac{1}{3}\end{matrix}$$

When the direction or the extending direction of the neighbor pixel p1 is within the aforementioned range, the neighbor pixel p1 and the center point p0 determined to be correlated, and the neighbor pixel p1 is marked with a respective correlation symbol. The correlation symbol is used to represent that the direction or the extending direction of the neighbor pixel passes the center point.

As discussed in above, the correlation between the neighbor pixel and the center point is further related to the position in which the neighbor pixel passes through the center point. For example, in FIG. 3a, the direction of the neighbor pixel p1 passes through the center of the center point p0, that is, θₚ_{₁}=135 in such case, the correlation between the neighbor pixel p1 and the center point p0 is strongest. In addition, if θₚ_{₁}=135 the correlation between the neighbor pixel p1 and the center point p0 is strongest as well; when θₚ_{₁} passes through the periphery of the center point, the correlation between the neighbor pixel and the center point is weakest. Therefore, in this embodiment, the correlation calculation module 13 is further used to:

calculate the correlation levels cₚ_{₁} of the neighbor pixels and the center point according to the range of the directions of the neighbor pixels, and confirm the correlations between the neighbor pixels and the center point according to the correlation symbols of the neighbor pixels and the correlation levels.

In this embodiment, the correlation levels cₚ_{₁} will be different when the directions of the neighbor pixels fall within different ranges, which can be implemented by the calculations discussed in above.

In this embodiment, correlation between each neighbor pixel and the center point is determined by analyzing the correlation symbol and the correlation level between the neighbor pixels and the center point, for providing references to the later process of calculating gray scale of the center point.

The present embodiment only provides exemplary calculation in related to correlation symbols of the neighbor pixels and correlation levels between neighbor pixels and the center point, but the present disclosure is not limited thereto, other calculations in related to determine correlation symbol and correlation level fall within the scope of the present disclosure.

The following is an embodiment for explaining the gray scale calculation module 14.

In this embodiment, the gray scale calculation module 14 is further used to:

calculate gray scale of the center point according to

$${p}_{0} = \frac{1}{n} \times {\sum }_{i = 1}^{n} {d}_{{p}_{1}} \times {c}_{{p}_{1}} \times {s}_{{p}_{1}} ,$$

wherein p₀ represents the gray scale of the center point, n represents the number of the neighbor pixels, dₚ_{ᵢ} represents the gradient magnitudes of the i^{th} neighbor pixel, cₚ_{ᵢ} represents the correlation level of the i^{th} neighbor pixel, sₚ_{ᵢ} represents the correlation symbol of the i^{th} neighbor pixel.

In this embodiment, according to the gradient magnitudes of each neighbor pixel and correlations between the neighbor pixels and the center point provided by the gradient-direction calculation module 12 and the correlation calculation module 13, gray scale of the center point is obtained, In this embodiment, the correlation between the neighbor pixel and the center point is confirmed by both the correlations and the correlation level, but this is exemplary, the present disclosure is not limited thereto, other ways to confirm the correlations between the neighbor pixels and the center point fall within the scope of the present disclosure.

When the neighbor pixels provided by the setting module 11 include any pixel has correlations with the center point, gray scale of the center point can be determined by gradient magnitudes and directions of each neighbor pixel having correlations with the center point. In addition, for an extreme case where the neighbor pixels provided by the setting module 11 and the center point do not have correlation therebetween, the way of confirming the gray scale of the center point provided in this embodiment is not applicable.

There are more embodiments for explaining how to confirm the gray scale of the center point when the neighbor pixel provided by the setting module 11 and the center point do not have correlation.

In one embodiment, the gray scale calculation module 14 is further used to: if all the neighbor pixels and the center point do not have correlation, an average gray scale of the neighbor pixels is calculated to be taken as the gray scale of the center point. For example, if all the gray scales of the neighbor pixels are the same value, the gray scale of the inserted pixel can be obtained by the way mentioned in the present embodiment.

In another embodiment, the gray scale calculation module 14 is further used to:

if all the neighbor pixels and the center point do not have correlation, the number of the neighbor pixels can be increased, so gray scale of the center point can be calculated according to the gradient magnitudes of the neighbor pixels and the correlations between the neighbor pixels and the center point.

For example, the number of the neighbor pixels around the center point can be increased from 6 to 14, the number can still be increased if the neighbor pixels and the center point have no correlation therebetween. When the neighbor pixels and the center point have correlations therebetween, gray scale of the center point is determined according to the gradient magnitudes and directions of the neighbor pixels having correlations with the center point.

One embodiment of the present disclosure provides a non-volatile computer storage medium capable of storing computer-executable instruction. The said computer-executable instruction is used for performing any one of the steps in above.

FIG. 5 is a schematic view of an electronic apparatus of one embodiment of the present disclosure, as shown in FIG. 5, the electronic apparatus includes a memory 52 and one or more processors 51. FIG. 5 is an example showing that the electronic apparatus having one processor 51.

The electronic apparatus includes: an input device 53 and an output device 54.

The processor 51, the memory 52, the input device 53 and the output device 54 can be connected to each other via a bus or other members for electrical connection. In FIG. 5, they are connected to each other via the bus in this embodiment.

Wherein, the memory 52 stores process which is executable by the processor, the computer-executable instruction is used for the processor 51 to perform so that the at least one processor 51 can execute any one of the steps provided by the image processing methods.

The memory 52 is one kind of non-volatile computer-readable storage mediums applicable to store non-volatile software programs, non-volatile computer-executable programs and modules; for example, the program instructions and the function modules (the setting module 11, the gradient-direction calculation module 12, the correlation calculation module 13, the gray scale calculation module 14, the dispatch module 15 and the interpolation module 16 in FIG. 4) corresponding to the method in the embodiments are respectively a computer-executable program and a computer-executable module. The processor 51 executes function applications and data processing of the server by running the non-volatile software programs, non-volatile computer-executable programs and modules stored in the memory 52, and thereby the methods in the aforementioned embodiments are achievable.

The memory 52 can include a program storage area and a data storage area, wherein the program storage area can store an operating system and at least one application program required for a function; the data storage area can store the data created according to the usage of the device for intelligent recommendation. Furthermore, the memory 52 can include a high speed random-access memory, and further include a non-volatile memory such as at least one disk storage member, at least one flash memory member and other non-volatile solid state storage member. In some embodiments, the memory 52 can have a remote connection with the processor 51, and such memory can be connected to the device of the present disclosure by a network. The aforementioned network includes, but not limited to, internet, intranet, local area network, mobile communication network and combination thereof.

The input device 53 can receive digital or character information, and generate a key signal input corresponding to the user setting and the function control of the device for intelligent recommendation. The output device 54 can include a displaying unit such as screen.

The one or more modules are stored in the memory 52. When the one or more modules are executed by one or more processor 51, the methods disclosed in any one of the embodiments is performed.

The aforementioned product can perform the method of the present disclosure, and has function module for performing it. The details not thoroughly illustrated in this embodiment can be referenced via the methods in the present disclosure.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are exemplary, the description of separated units can be physically connected, and the unit capable of displaying image can not be a physical unit, that is, it can be located on a place or distributed to plural internet units. It is selectively to select a part or all of the modules for achieving the purpose of the present disclosure.

By the aforementioned embodiments, the people skilled in the art can thoroughly understand that the embodiments can be implemented by software and hardware platform. Accordingly, the technique, features or the part having contribution can be embodied through software product, the software product can be stored in computer readable medium, such as ROM/RAM, hard disk, optical disc, including one or more instructions so that a computing apparatus (e.g. personal computer, server, or internet apparatus can execute each embodiment or some methods discussed the embodiments.

It is further noted that: the embodiments in above are only used to explain the features of the present application, but not used to limit the present application; although the present application is explained by the embodiments, the people skilled in the art would know that the features in the aforementioned embodiments can be modified, or a part of the features can be replaced, and the features relating to these modification or replacement are still in the scope and spirit of the present application.

What is claimed is:

1. A method of processing image data, comprising:
taking an inserted pixel as a center point to determine neighbor pixels of the center point;
obtaining gradient magnitudes and directions of each neighbor pixel;
calculating correlations between each neighbor pixel and the center point according to the directions of each neighbor pixel;
calculating the gradient magnitudes of each neighbor pixel and the correlations between the neighbor pixel and the center point to obtain gray scale of the center point which is gray scale of the inserted pixel;
taking other inserted pixels each as a center point to obtain gray scale thereof, and determining color of each inserted pixel according to all the gray scales of the inserted pixels;
obtaining an image with increased image resolution according to each inserted pixel and the color thereof and original pixels and the color thereof;
wherein, the correlation is determined by whether the direction of the neighbor pixel passes through the center point and the position in which the direction of the neighbor pixel passes through the center point.

2. The method according to claim 1, wherein the obtaining gradient magnitudes and directions of each neighbor pixel comprises:
calculating gradient dₓ^{p}^{₁} of the neighbor pixel in x-direction according to dₓ^{p}^{₁}=(a₃−a₁)+2□(p₂−a₆)+(p₅−a₈), wherein, a₁, a₃, a₆, a₈, p₂, p₅ are gray scales of the original pixels in the neighbor pixel;
calculating gradient d_{y}^{p}^{₁} of the neighbor pixel in y-direction according to d_{y}^{p}^{₁}=(a₁−a₈)+2□(a₂−p₄)+(a₃−p₅), wherein, a₁, a₂, a₃, a₈, p₄, p₅ are gray scales of the original pixels in the neighbor pixel;
calculating gradient magnitude dₚ_{₁} of the neighbor pixel according to dₚ_{₁}=\sqrt{(dₓ^{p}^{₁})²+(d_{y}^{p}^{₁})²}; and
calculating direction θₚ_{₁} of the neighbor pixel according to
$${θ}_{{p}_{1}} = {tan}^{- 1} \frac{{d}_{y}^{{p}_{1}}}{{d}_{x}^{{p}_{1}}} .$$

3. The method according to claim 1, wherein the calculating correlations between each neighbor pixel and the center point according to the directions of each neighbor pixel comprises:
taking each neighbor pixel as a 1×1 square, if a direction θₚ_{₁} of the neighbor pixel is in [2π−tan⁻¹3, 2π−tan⁻¹⅓], or an extending direction θₚ_{₁} of the opposite direction of the neighbor pixel is in [π−tan⁻¹3, π−tan⁻¹⅓], defining the neighbor pixel and the center point has correlation, and the neighbor pixel is marked with a correlation symbol according to
$${s}_{{p}_{1}} = \{ \begin{matrix}1 when \text{:} 2 π - {tan}^{- 1} 3 \leq {θ}_{{p}_{1}} \leq 2 π - {tan}^{- 1} \frac{1}{3} \\ - 1 when \text{:} π - {tan}^{- 1} 3 \leq {θ}_{{p}_{1}} \leq π - {tan}^{- 1} \frac{1}{3}\end{matrix} .$$

4. The method according to claim 3, wherein the calculating correlations between each neighbor pixel and the center point according to the directions of each neighbor pixel comprises:
calculating correlation level cₚ_{₁} of the neighbor pixel and the center point according to range of the directions of the neighbor pixel, and determining correlations between the neighbor pixel and the center point according to the correlation symbol of the neighbor pixel and the correlation level.

5. The method according to claim 1, wherein the calculating the gradient magnitudes of each neighbor pixel and the correlations between the neighbor pixel and the center point to obtain gray scale of the center point comprises:
calculating gray scale of the center point according to
$${p}_{0} = \frac{1}{n} \times {\sum }_{i = 1}^{n} {d}_{{p}_{1}} \times {c}_{{p}_{1}} \times {s}_{{p}_{1}} ,$$
wherein p₀ represents the gray scale of the center point, n represents the number of the neighbor pixels, dₚ_{ᵢ} represents gradient magnitudes of the i^{th} neighbor pixel, cₚ_{ᵢ} represents the correlation level of the i^{th} neighbor pixel, sₚ_{ᵢ} represents the correlation symbol of the i^{th} neighbor pixel.

6. The method according to claim 1, wherein the calculating the gradient magnitudes of each neighbor pixel and the correlations between the neighbor pixel and the center point to obtain gray scale of the center point comprises:
taking an average gray scale of the neighbor pixels as the gray scale of the center point if all the neighbor pixels and the center point have no correlation.

7. The method according to claim 1, wherein the calculating the gradient magnitudes of each neighbor pixel and the correlations between the neighbor pixel and the center point to obtain gray scale of the center point comprises:
increasing the number of the neighbor pixels, and obtaining gray scale of the center point according to the gradient magnitudes of the added neighbor pixel and the correlations between the neighbor pixels and the center point if all the neighbor pixels and the center point have no correlation.

8. A non-volatile computer storage medium capable of storing computer-executable instruction, the computer-executable instruction comprising:
taking an inserted pixel as a center point to determine neighbor pixels of the center point;
obtaining gradient magnitudes and directions of each neighbor pixel;
calculating correlations between each neighbor pixel and the center point according to the directions of each neighbor pixel;
calculating the gradient magnitudes of each neighbor pixel and the correlations between the neighbor pixel and the center point to obtain gray scale of the center point which is gray scale of the inserted pixel;
taking the other inserted pixels each as a center point to obtain gray scale thereof, and determining color of each inserted pixel according to all the gray scales of the inserted pixels;
obtaining an image with increased image resolution according to each inserted pixel and the color thereof and original pixels and the color thereof;
wherein, the correlation is determined by whether the direction of the neighbor pixel passes through the center point and the position in which the direction of the neighbor pixel passes through the center point.

9. The non-volatile computer storage medium according to claim 8, wherein the obtaining gradient magnitudes and directions of each neighbor pixel comprises:
calculating gradient dₓ^{p}^{₁} of the neighbor pixel in x-direction according to dₓ^{p}^{₁}=(a₃−a₁)+2□(p₂−a₆)+(p₅−a₈), wherein, a₁, a₃, a₆, a₈, p₂, p₅ are gray scales of the original pixels in the neighbor pixel;
calculating gradient d_{y}^{p}^{₁} of the neighbor pixel in y-direction according to d_{y}^{p}^{₁}=(a₁−a₈)+2□(a₂−p₄)+(a₃−p₅), wherein, a₁, a₂, a₃, a₈, p₄, p₅ are gray scales of the original pixels in the neighbor pixel;
calculating gradient magnitude dₚ_{₁} of the neighbor pixel according to dₚ_{₁}=\sqrt{(dₓ^{p}^{₁})²+(d_{y}^{p}^{₁})²}; and
calculating direction θₚ_{₁} of the neighbor pixel according to
$${θ}_{{p}_{1}} = {tan}^{- 1} \frac{{d}_{y}^{{p}_{1}}}{{d}_{x}^{{p}_{1}}} .$$

10. The non-volatile computer storage medium according to claim 8, wherein the calculating correlations between each neighbor pixel and the center point according to the directions of each neighbor pixel comprises:
taking each neighbor pixel as a 1×1 square, wherein if a direction θₚ_{₁} of the neighbor pixel is in [2π−tan⁻¹3, 2π−tan⁻¹⅓], or an extending direction θₚ_{₁} of the opposite direction of the neighbor pixel is in [π−tan⁻¹3, π−tan⁻¹⅓], the neighbor pixel and the center point has correlation, and the neighbor pixel is marked with a correlation symbol according to
$${s}_{{p}_{1}} = \{ \begin{matrix}1 when \text{:} 2 π - {tan}^{- 1} 3 \leq {θ}_{{p}_{1}} \leq 2 π - {tan}^{- 1} \frac{1}{3} \\ - 1 when \text{:} π - {tan}^{- 1} 3 \leq {θ}_{{p}_{1}} \leq π - {tan}^{- 1} \frac{1}{3}\end{matrix} .$$

11. The non-volatile computer storage medium according to claim 10, wherein the calculating correlations between each neighbor pixel and the center point according to the directions of each neighbor pixel comprises:
calculating correlation level cₚ_{₁} of the neighbor pixel and the center point according to range of the directions of the neighbor pixel, and determining correlations between the neighbor pixel and the center point according to the correlation symbol of the neighbor pixel and the correlation level.

12. The non-volatile computer storage medium according to claim 8, wherein the calculating the gradient magnitudes of each neighbor pixel and the correlations between the neighbor pixel and the center point to obtain gray scale of the center point comprises:
calculating gray scale of the center point according to
$${p}_{0} = \frac{1}{n} \times {\sum }_{i = 1}^{n} {d}_{{p}_{1}} \times {c}_{{p}_{1}} \times {s}_{{p}_{1}} ,$$
wherein p₀ represents the gray scale of the center point, n represents the number of the neighbor pixels, dₚ_{ᵢ} represents gradient magnitudes of the i^{th} neighbor pixel, cₚ_{ᵢ} represents the correlation level of the i^{th} neighbor pixel, sₚ_{ᵢ} represents the correlation symbol of the i^{th} neighbor pixel.

13. The non-volatile computer storage medium according to claim 8, wherein the calculating the gradient magnitudes of each neighbor pixel and the correlations between the neighbor pixel and the center point to obtain gray scale of the center point comprises:
taking an average gray scale of the neighbor pixels as the gray scale of the center point if all the neighbor pixels and the center point have no correlation.

14. The non-volatile computer storage medium according to claim 8, wherein the calculating the gradient magnitudes of each neighbor pixel and the correlations between the neighbor pixel and the center point to obtain gray scale of the center point comprises:
increasing the number of the neighbor pixels, and obtaining gray scale of the center point according to the gradient magnitudes of the added neighbor pixel and the correlations between the neighbor pixels and the center point if all the neighbor pixels and the center point have no correlation.

15. An electronic apparatus, comprising:
at least one processor; and
a memory communicatively connected to the at least one processor; wherein
the memory stores computer-executable instruction which is executable by the at least one processor, when the computer-executable instruction is executed by the at least processor, the at least one processor is able to:
take an inserted pixel as a center point to determine neighbor pixels of the center point;
obtain gradient magnitudes and directions of each neighbor pixel;
calculate correlations between each neighbor pixel and the center point according to the directions of each neighbor pixel;
calculate the gradient magnitudes of each neighbor pixel and the correlations between the neighbor pixel and the center point to obtain gray scale of the center point which is gray scale of the inserted pixel;
take the other inserted pixels each as a center point to obtain gray scale thereof, and determining color of each inserted pixel according to all the gray scales of the inserted pixels;
obtain an image with increased image resolution according to each inserted pixel and the color thereof and original pixels and the color thereof;
wherein, the correlation is determined by whether the direction of the neighbor pixel passes through the center point and the position in which the direction of the neighbor pixel passes through the center point.

16. The electronic apparatus according to claim 15, wherein the obtaining gradient magnitudes and directions of each neighbor pixel comprises:
calculating gradient dₓ^{p}^{₁} of the neighbor pixel in x-direction according to dₓ^{p}^{₁}=(a₃−a₁)+2□(p₂−a₆)+(p₅−a₈), wherein, a₁, a₃, a₆, a₈, p₂, p₅ are gray scales of the original pixels in the neighbor pixel;
calculating gradient d_{y}^{p}^{₁} of the neighbor pixel in y-direction according to d_{y}^{p}^{₁}=(a₁−a₈)+2□(a₂−p₄)+(a₃−p₅), wherein, a₁, a₂, a₃, a₈, p₄, p₅ are gray scales of the original pixels in the neighbor pixel;
calculating gradient magnitude dₚ_{₁} of the neighbor pixel according to dₚ_{₁}=\sqrt{(dₓ^{p}^{₁})²+(d_{y}^{p}^{₁})²}; and
calculating direction θₚ_{₁} of the neighbor pixel according to
$${θ}_{{p}_{1}} = {tan}^{- 1} \frac{{d}_{y}^{{p}_{1}}}{{d}_{x}^{{p}_{1}}} .$$

17. The electronic apparatus according to claim 15, wherein the calculating correlations between each neighbor pixel and the center point according to the directions of each neighbor pixel comprises:
taking each neighbor pixel as a 1×1 square, if a direction θₚ_{₁} of the neighbor pixel is in [2π−tan⁻¹3, 2π−tan⁻¹⅓], or an extending direction θₚ_{₁} of the opposite direction of the neighbor pixel is in [π−tan⁻¹3, π−tan⁻¹⅓], defining the neighbor pixel and the center point has correlation, and the neighbor pixel is marked with a correlation symbol according to
$${s}_{{p}_{1}} = \{ \begin{matrix}1 when \text{:} 2 π - {tan}^{- 1} 3 \leq {θ}_{{p}_{1}} \leq 2 π - {tan}^{- 1} \frac{1}{3} \\ - 1 when \text{:} π - {tan}^{- 1} 3 \leq {θ}_{{p}_{1}} \leq π - {tan}^{- 1} \frac{1}{3}\end{matrix} ;$$
calculating correlation level cₚ_{₁} of the neighbor pixel and the center point according to range of the directions of the neighbor pixel, and determining correlations between the neighbor pixel and the center point according to the correlation symbol of the neighbor pixel and the correlation level.

18. The electronic apparatus according to claim 15, wherein the calculating the gradient magnitudes of each neighbor pixel and the correlations between the neighbor pixel and the center point to obtain gray scale of the center point comprises:
calculating gray scale of the center point according to
$${p}_{0} = \frac{1}{n} \times {\sum }_{i = 1}^{n} {d}_{{p}_{1}} \times {c}_{{p}_{1}} \times {s}_{{p}_{1}} ,$$
wherein p₀ represents the gray scale of the center point, n represents the number of the neighbor pixels, dₚ_{ᵢ} represents gradient magnitudes of the i^{th} neighbor pixel, cₚ_{ᵢ} represents the correlation level of the i^{th} neighbor pixel, sₚ_{ᵢ} represents the correlation symbol of the i^{th} neighbor pixel.

19. The electronic apparatus according to claim 15, wherein the calculating the gradient magnitudes of each neighbor pixel and the correlations between the neighbor pixel and the center point to obtain gray scale of the center point comprises:
taking an average gray scale of the neighbor pixels as the gray scale of the center point if all the neighbor pixels and the center point have no correlation.

20. The electronic apparatus according to claim 15, wherein the calculating the gradient magnitudes of each neighbor pixel and the correlations between the neighbor pixel and the center point to obtain gray scale of the center point comprises:
increasing the number of the neighbor pixels, and obtaining gray scale of the center point according to the gradient magnitudes of the added neighbor pixel and the correlations between the neighbor pixels and the center point if all the neighbor pixels and the center point have no correlation.
